(19) United States
(12) Patent Application Publication
(10) Pub. No.: US 2010/0088137 A1
(43) Pub. Date: Apr. 8, 2010

(54) WORK LISTS AND COCKPIT TO CONTROL COMPLEX PROCESSES

(76) Inventors: KLAUS WEISS, Hassloch (DE); Juergen Kind, Ostringen (DE); Hans-Dieter Loew, Leimen (DE); Friedhelm Mause, Hirschberg-Grossachsen (DE); Dagmar Mayer, Beilstein (DE); Lothar Rieger, Bammental (DE); Janet Dorothy Salmon, Dudenhofen (DE)

Correspondence Address: SAP AG, 3410 HILLVIEW AVENUE, PALO ALTO, CA, 94304, US

(21) Appl. No.: 12/245,792

(22) Filed: Oct. 6, 2008

(51) Int. Cl. G06Q 10/00

(52) U.S. Cl. 705/8; 705/7

(57) ABSTRACT

A method, system and article of manufacture for creating a worklist and organizing a cockpit to control complex processes execution. A process hierarchy is created, including a plurality of organizational levels. A worklist of a plurality of worktasks, grouped in accordance with the process hierarchy, is created. The plurality of worktasks includes both internal worktasks, to be executed on a local computer system, and external worktasks, to be executed on external computer systems. A number of worklist views are displayed, where each worklist view includes a corresponding subset of the plurality of worktasks organized in accordance with the process hierarchy. Executions of internal and external worktasks are initiated from one or more of the worklist. Further, detailed information relevant to the execution is received. The executions of the tasks are monitored on one the worklist views.

### FIELD OF INVENTION

The field of invention relates generally to electronic data processing and more particularly to controlling complex processes execution.

### BACKGROUND

Currently there is a high demand for fast preparation of financial statements. More stringent compliance and financial reporting requirements mandate closing books faster with little tolerance for errors. Compliance requires stricter accounting policies and ability to document the application of such policies. There is a growing need for finance to play a higher value-added role in the business. This means to spend less resources on information gathering, reconciling, and adjusting numbers. The demand and the need to decrease the overall cost of finance requires more automation, efficiency, and process standardization.

For example, in large enterprises, the number of different tasks that have to be carried out during a period end close process may amount to several thousand tasks. These tasks may comprise tasks that can be executed automatically and task that have to be carried out manually. A task that can be automated is a payroll run that is executed in a Human Capital Management (HCM) system or a billing run in a Financial (FI) system. Typical manual tasks are checks for completeness and correctness or correction postings that have to be carried out in a FI system by finance accountants. Most sizable businesses use scheduling tools for process automation. Companies have been trying to reform their financial processes for years without much success. There are many barriers to fast processing. Further, there is a key impact on financial teams members as well. A poorly controlled and coordinated financial cycle leads to employee unsatisfaction and turn over.

Businesses with complex Enterprise Resource Planning (ERP) information system landscape wish to control complex financial processes centrally. Thus, they are able to monitor the degree of processing over the complete process and to have one central store for audit later. Although the legal statutes may differ from country to country, audits of financial statements are usually required everywhere for investment, financing, and tax purposes.

Just as enterprises have undertaken process automation in other operational areas, now they need to invest in efforts to institute reliable and sustainable financial processes that are automated with the help of technology. This would provide various benefits like reduced costs, compliance, more reliable data, and more time for making decisions upon the data. In addition, this would lead to increasing investor confidence and would benefit the overall rating of a company in a long run.

### SUMMARY

A method, system and article of manufacture for creating a worklist and organizing a cockpit to control complex processes execution are described. A process hierarchy is created, including a plurality of organizational levels. A worklist of a plurality of worktasks, grouped in accordance with the process hierarchy, is created. The plurality of worktasks includes both internal worktasks, to be executed on a local computer system, and external worktasks, to be executed on external computer systems. A number of worklist views are displayed, where each worklist view includes a corresponding subset of the plurality of worktasks organized in accordance with the process hierarchy. Executions of internal and external worktasks are initiated from one or more of the worklist. Further, detailed information relevant to the execution is received. The executions of the tasks are monitored on one the worklist views.

### BRIEF DESCRIPTION OF THE DRAWINGS

A better understanding of the present invention can be obtained from the following detailed description in conjunction with the figures of the accompanying drawings in which like references indicate similar elements. It should be noted that references to “an” or “one” embodiment in this disclosure are not necessarily to the same embodiment, and such references mean at least one.

FIG. 1 illustrates a flowchart of a procedure to create a worklist template, according to one embodiment of the invention.

FIG. 2 illustrates a flowchart of a procedure to initiate and monitor worktasks execution, according to one embodiment of the invention.

FIG. 3 illustrates a flowchart of a procedure to display detailed status information about worktasks execution, and to provide access to associated functions, according to one embodiment of the invention.

FIG. 4 illustrates a block diagram of a system to control complex processes, according to one embodiment of the invention.

FIG. 5 illustrates an embodiment of a graphical user interface (GUI) of a Closing Cockpit displaying a worklist, according to one embodiment of the invention.

FIG. 6 illustrates an embodiment of a GUI of a Closing Cockpit displaying worktasks organized in a tree structure, according to one embodiment of the invention.

FIG. 7 illustrates an embodiment of a GUI of a Closing Cockpit displaying worktasks in a Gantt chart, according to one embodiment of the invention.

### DETAILED DESCRIPTION

Embodiments of a method and a system for providing worklists and a cockpit to control complex processes are described.

In one embodiment of the invention, a controlling cockpit is deployed to provide web access to a list of process tasks and related files for all users associated with a process. The users may have different responsibilities and roles in the process. Different subsets of tasks or worktasks might be associated to different users. The cockpit allows users to access corresponding worktasks and to perform a variety of actions, including scheduling and initiating execution of worktasks, monitoring the process, reporting status information, etc.

All users involved in the process can see the status of the corresponding subset of worktasks in the controlling cockpit. It is possible for the users to see statuses of worktasks corresponding to other stakeholders. The users could access spool lists, job logs, application logs, and any available documentation for the worktasks from the cockpit. In addition, users can record comments and capture email communication relating to issues encountered in the process. Thus, worktask lists, accessible through the cockpit, could be used to document compliant completion of the process. For reasons of compliance, it is often important to document not only that the job had been completed without errors, but also that a user has checked the results and can confirm that they are correct.

Whenever there is a move to handling the process as a shared service for several companies, there is a need to automate tasks across different computer systems. The list of worktasks accessible through the controlling cockpit could include local worktasks and remote worktasks. The local worktasks are executed in a local computer system, where the controlling cockpit is also executed. The remote worktasks are executed in one or more computer systems, other than the system containing the controlling cockpit. For example, such as systems where production is taking place and the orders need to be settled or a system on a lower ERP release level. A number of separate schedulers in each involved computer system are integrated by the controlling cockpit. The exact architecture of the local and remote computer systems may vary in different embodiments of the invention and may include standalone system and distributed system architectures.

Controlling cockpit provides functionality to manage all background and transaction-like or online worktasks of a process distributed across multiple systems and across all involved clients. The worktask scheduling across systems could be enhanced to handle other variables, such as multiple time zones and users of different systems. Background worktasks can be scheduled in the cockpit to be triggered by a calendar entry or by real-time events. Worktasks executed in a transaction-like manner can be started directly from within controlling cockpit across multiple computer systems by corresponding users.

Controlling cockpit ensures an overview of the entire process execution with potential system dependencies. This enables enterprise wide control and monitoring of distributed processes and helps to reduce latency between dependent sub-processes and data sources. The level of process automation is increased at its highest, which reduces the error-prone manual operations. The results delivered by highly automated financial processes are more reliable. The document flow, supported by the integrated controlling cockpit, is adjusted for a compliance and efficient audit.

A distributed process comprises a plurality of worktasks executed over multiple systems. The controlling cockpit facilitates execution of processes in large enterprises where complex organizational hierarchies exist. Execution of each worktask must be performed in corresponding organizational unit and there are one or more computer system users from the unit, responsible for the execution of each worktask. The execution of a worktask could be initiated or manually performed by a processor user. The work of one or more processor users might be monitored by a supervisor user. The result of process execution is reviewed by auditors. The hierarchy and work of the users are organized through the controlling cockpit.

The worktasks, the order of execution, and the involved users provide the global plan of the process. This plan is defined in the controlling cockpit. In one embodiment of the invention, a template is created in the controlling cockpit, describing the global plan of a distributed process. Such a template contains a list of worktasks representing all steps of a process grouped by organizational units, including default parameters and documentation.

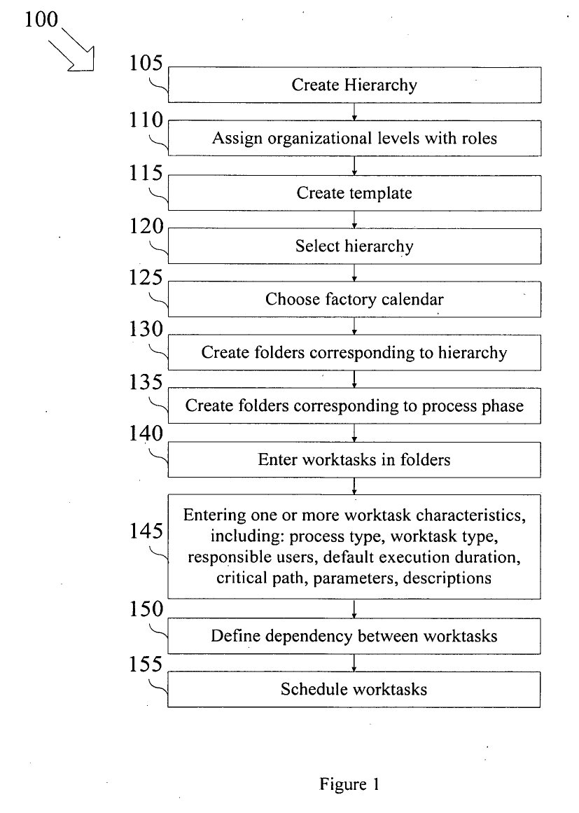

FIG. 1 is a flowchart 100 of a procedure to create a worklist template. At block 105, a hierarchy is created in the controlling cockpit to describe a number of organizational objects. The hierarchy determines an organizational structure of units and responsible users involved in one or more processes. The hierarchy is created by defining one or more organizational levels or objects and their properties. The properties include, for example, the types of the organizational objects, subordination between the objects, and substructure for each organizational object. Worktasks of a process are grouped in accordance with the hierarchy. For example, special features of individual independent accounting units might be considered during the process to avoid applying identical process steps to all of them at a company level.

As was mentioned above, different categories of users have different responsibilities in process execution. At block 110, roles are assigned to the defined organizational levels specifying the responsibilities of the users within the created hierarchy of the process. For example, processor or supervisory roles could be assigned to an organizational object of type accounting unit, and an auditor role could be assigned to a controlling organizational object. It is possible also to assign individual users and roles in the hierarchy, such as Asset Accountant, Cost Accountant, etc. In a controlling cockpit different hierarchies could be created and stored for different processes.

A worklist template object for a particular process is created at block 115. In another embodiment of the invention, one template could be used for more than one process. For example, the worklist template could include worktasks for a month-end process and for a quarter-end process. The scope of a template is not determined by application-related aspects. Instead, its scope may be oriented towards the overall process and the organizational units involved. At block 120 appropriate process hierarchy is selected for the created template. With block 125 is illustrated an option to choose a factory calendar for the template. This calendar contains the working days and is to be applied when scheduling the worktasks of the process.

A structure of folders and subfolders corresponding to the process hierarchy is defined within the template at block 130. There is correspondence between this structure and the selected hierarchy that predefines roles and default parameters for execution of process worktasks. Further, at block 135, a structure of folders and subfolders is defined corresponding to different process phases. The term “process phase” is used to describe functional grouping of process steps. For example, according to this definition, process phases are payroll, invoicing, allocation, order settlement, data extraction to consolidation, etc. Subfolders could be created under a hierarchy level to further structure the worktasks in the worklist template. In such a way the worklist template structures the overall process in subgroups of process steps at the organizational level and portrayed it in folder form.

At block 140, the worktasks of the process are entered in the template. The worktasks of the process could be entered manually or imported from other programs, e.g. external schedulers, databases, files etc. Each worktask is assigned within the defined folder structure, according to the process hierarchy and the process phases. In one embodiment of the invention the worktasks are added to a particular folder of the template from within the controlling cockpit by choosing a menu item or pushing a button. There are various characteristics or attributes for each worktask in the worklist template that need to be specified at block 145. For example, a type of a worktask is selected to show whether it is a background process, online transaction or manual task. Further, the task is categorized as local or remote, according to whether it is executed in the same computer system where the controlling cockpit is running, or whether it is executed in an external system.

Another characteristic of a worktask could be a responsible user or person for executing the worktask and for monitoring the execution. This characteristic could be either entered manually of inherited from the roles associated to the hierarchy levels where the worktask is assigned. When the worklist template includes worktasks for more than one process, a worktask attribute could specify the pertinent process. Yet another attribute of a worktask could specify the expected duration of the worktask execution. Additionally, a message or a note for each or for some of the worktask of the template could be entered.

An important characteristic to be defined for a worktask is one or more default parameters or input variants. Some of the worktasks, especially those executed as background procedures, require input values in order to start. Standard programs are generally available for processing activities in the background. If these programs or worktasks are included in the worklist template with corresponding parameters or variants, they can later start batch processing directly from the cockpit. Further, flow definitions could be used for multiple worktasks to be processed automatically without interruption. Such tasks are combined with input variants to form a logical flow chain with unique predecessor and successor relationships. A worktask which execution is critical for the process could be flagged as belonging to the critical path of the process.

The worklist template could be interpreted as a default project plan of the process or processes. The worktasks that have been included in the template frequently involve business-related or system-related dependencies that need to be portrayed for the process flow to be processed smoothly. Referring again to FIG. 1, the dependencies between the process worktasks are entered in the template at block 150. In general, these dependencies define relationships between a worktasks, specifying that a worktask could be executed after a successful execution of one or more predecessor worktasks.

The worklist template provides a precise schedule for execution of the process worktasks, based on a key date. The worktasks in the template are scheduled in accordance with this key date at block 155. Some of the worktasks could be scheduled for execution before the key date, e.g., the tasks of invoicing and payroll phases. Other worktasks are scheduled to take place at a particular moment or event after the key date, e.g., the tasks of allocation and order settlement phases. When a factory calendar is selected at block 125, working and non-working days are taken into account in process worktasks scheduling.

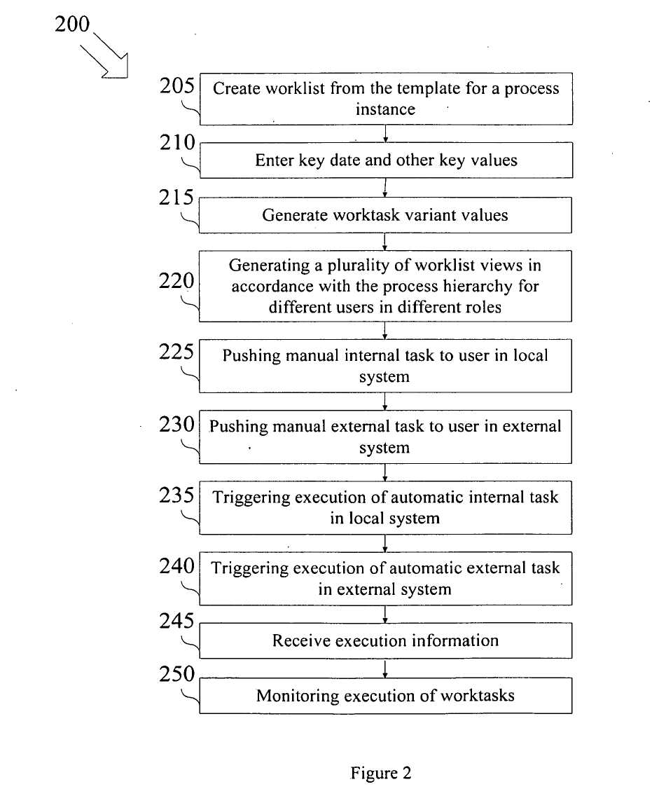

FIG. 2 is a flowchart 200 of a procedure to initiate and monitor worktask execution, according to one embodiment of the invention. Once the setting of the worklist template is completed, a worktask list could be generated at block 205. The generated worklist describes all tasks and responsibilities for an individual process instance. This will automatically create a proposal for the timing of the individual worktasks to take account of any dependencies. The exact scheduling of the individual process instance is accomplished when the key date is specified in the generated worklist at block 210. At block 210, other key values could also be entered or selected from a list of automatic proposals. For example, other key values could specify overall process duration, a responsible person or persons, user authorization scheme, etc.

In order to perform programs included in a task list, it may be necessary to generate or specify parameters or variants for worktasks at block 215. For example, the time-related worktasks parameters are generated when the worklist is generated and the key date is entered. According to how worktasks parameters are defined in the worklist template, this element of flowchart 200 could be completely automated.

Once generated in the controlling cockpit, worklists could be used for organizing and monitoring the execution of the corresponding process instance. At block 220, a number of different views of the worklist are generated. Each view shows a subset of the worktasks and is accessible by a predefined group of users in accordance with the process hierarchy and assigned roles. Thus, processor users from a specific organizational unit will have access to those worktasks for which they are directly responsible. A supervisor user will have access to all worktasks performed by users on the same or lower hierarchy level. An independent auditor could have access to a view containing all worktasks from the worklist.

The controlling cockpit provides access to the worktasks in the worklist views. This access depends on user authorizations and could involve different actions. A processor user could initiate or push a worktask execution in the local system at block 225, or in an external system at block 230. Alternatively, the controlling cockpit could trigger or invoke the execution of a worktask in the local system at block 235, or in an external system at block 240, when a certain condition is met, or at a certain event.

At block 245, the controlling cockpit receives status information from the computer systems during the execution of the worktasks in the worklist. At block 250, the controlling cockpit makes the status information available in the worklist views, and the process execution could be monitored by the users.

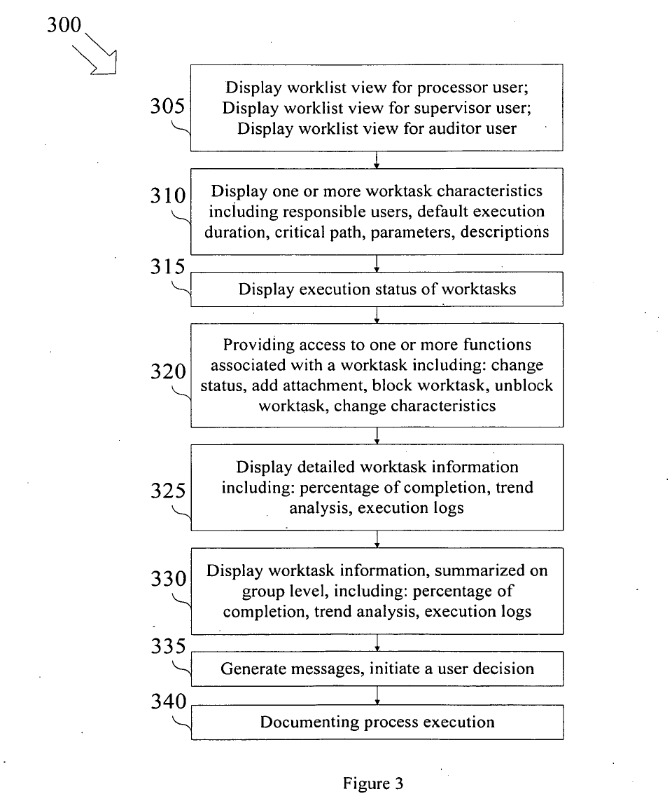

FIG. 3 is a flowchart 300 of a procedure to display a detailed status information about worktasks execution, and to provide access to associated functions, according to one embodiment of the invention. At block 305, specific worklist views are created and displayed to different categories of users, according to the established process hierarchy and associated user roles. The controlling cockpit displays relevant subsets of worktasks, including various worktasks characteristics at block 310. The displayed characteristics of a worktask could provide information for a user or a person responsible for the correct worktask execution; the default execution duration of the worktask; worktask belonging to a critical path; updated parameters; assigned messages or notes, etc.

The controlling cockpit also shows the received execution status of the worktasks in the displayed views at block 315. Further, according to the user authorization, the controlling cockpit provides access to one or more functions associated with a worktask through the displayed view at block 320. The functions might include status change, add attachments, block the worktask, unblock the worktask, change attribute of the worktask, etc.

The controlling cockpit displays detailed information for the execution of the worktasks at block 325. In one embodiment, the detailed information includes percentage of completion of a worktask; percentage of completion of the entire process; trend analyses; and access to job logs, spool lists, and application logs created in multiple computer systems during execution of the worktasks. At block 330, the controlling cockpit displays the same information summarized in different groups, according to process structure and hierarchy. Further, at block 335, the controlling cockpit provides interface for generating messages when an error or other event occurs during process execution and for initiating a user action or decision before continuing the process execution.

The functionality illustrated with block 335 provides interaction necessary for workflow integration. For example, if a worktask is locked and a user tries to unlock this worktask, a workflow is triggered. The triggered workflow sends a message containing a request for approval to a user with the respective privileges. That there is such a workflow for a worktask would be defined in the worklist template. The displayed information and all other electronic data, relevant to the individual process instance execution, are centrally stored for further analysis and audit at block 340.

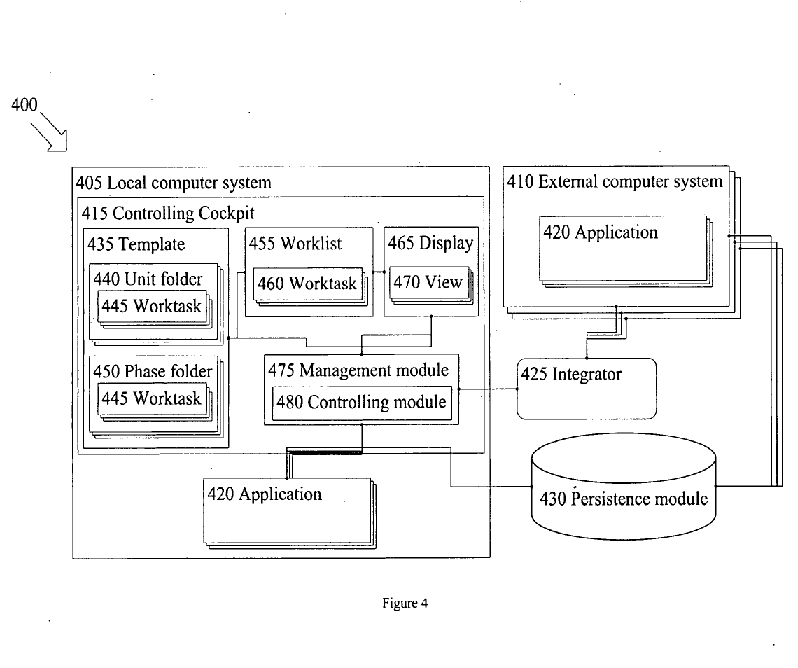

FIG. 4 is a block diagram of a system 400 to control complex processes, according to one embodiment of the invention. System 400 includes local computer system 405. Local system 405 includes controlling cockpit 415. A number of external computer systems 410 are in communication with local computer system 405. In local computer system 405 and in external computer systems 410 applications 420 run to execute worktasks of one or more financial processes. For example, applications 420 may be Human Capital Management (HCM) system or a billing run in a Financial (FI) system.

Process execution is organized and facilitated by cockpit 415. In template 435 of cockpit 415 a project plan of a process is created, including all relevant worktasks 445. Worktasks are grouped in accordance with a hierarchy structure, represented by a set of organizational unit folders 440 and process phase folders 450.

Based on template 435, worklist 460 is generated comprising worktasks 460. Worktasks 460 are versions of worktasks 445 updated with actual parameters relevant to a process instance. Cockpit 415 provides a plurality of views 470 for different users through display module 465. Display module 465 offers access to one or more functions in accordance with execution statuses of the worktasks including worktask status change, add attachments, block worktasks, unblock worktasks, update parameters of worktasks, etc.

Cockpit 415 includes management module 475 to initiate an execution of worktasks 460 in applications 420 in local computer system 405 or in external computer systems 410. Management module 475 comprises controlling module 480 for dynamically monitoring the process execution by providing access to detailed information received from applications 420. Display module 465 displays the received detailed information showing percentage of completion of a worktask or a group of worktasks execution, trend analyses, links to execution logs and spool files, etc.

Display module 465 provides a graphical user interface (GUI) to display the information regarding the worktasks. The GUI visualizes the worktasks, which have to be carried out during the process, and enables a user to perform the necessary functions or actions. Besides the worklist, containing all or a subset of the worktasks of the process, GUI visualizes a tree control to provide all important information, and enables a user for fast data entry, for example, to change date and time. Furthermore, there is a Gantt chart view to visualize dimensions of the displayed worktasks and to provide graphical information on the dependencies between worktasks.

In GUI, worktasks of different categories (manual, remote, etc.) are shown in different colors, and worktasks of different types (transaction, program, etc.) are shown in different shape, according to one embodiment of the invention. If a user has certain authorizations, start and end date/time of a worktask can easily be changed by drag and drop. Worktasks can be selected and, depending on the type, they can be executed, scheduled, or just locked/unlocked. The Graphical view is configured by using Extensible Stylesheet Language Transformations (XSLT) transformations and can be adjusted by customers.

System 400 comprises persistence storage 430 to keep all electronic data relevant to process execution that includes the detailed information. Cockpit 415 communicates with external computer systems 410 through integrator 425. With the help of integrator 425, cockpit 475 manages the execution of worktasks 460 in applications 420 on external computer systems 410 in the same manner as it manages the execution of worktasks 460 in applications 420 on local computer system 405.

An exemplary embodiment of the invention is Closing Cockpit application provided by SAP AD to control closing period processes within an enterprise. SAP Closing Cockpit is available in SAP ERP™ product version 6.0, enhancement package 3. SAP Closing Cockpit utilizes SAP Central Process Scheduler (CPS). SAP CPS provides an application programming interface (API) to an ERP system containing the Closing Cockpit, and communicates via Remote Function Call (RFC) interface with any other system involved in the close process, e.g., SAP ERP systems on lower releases or non-SAP systems.

In SAP CPS are defined two SAP system connections one for the ERP system containing the Closing Cockpit and one for a number of remote systems. The first SAP system connection refers to the ERP system in which the Closing Cockpit resides. This must be on SAP ERP 6.0, enhancement package 3 or later. This system will communicate with the Scheduler (SAP CPS) via the API. The second SAP system connection refers to the remote system in which some remote or external worktasks will be performed. When the close worktask is executed from the ERP system containing the Closing Cockpit, the worktask is routed to the remote system via RFC interface.

In SAP CPS, it is also necessary to create two job definitions, one for a remote job or program with variants, and one for alerting. The first job will provide the framework in SAP CPS for starting jobs remotely. The term “program with variant” or “job with variant” means a worktask or a job executed in system background mode. When a remote job is created in the template, this job definition is chosen from SAP CPS, and the individual parameters in the template are entered, for example, job name, program name, variant, client, language, and user. The second job definition provides a framework in SAP CPS for starting transactions remotely. When a remote task is created in the template, this job definition is chosen from SAP CPS, and the individual parameters are entered in the template transaction, client, language, user, etc. The second job definition is used to check if an event did occur.

For jobs where the same selection criteria are used for a sequence of jobs (e.g. calculate overhead for projects, perform results analysis for projects, settle projects), it is possible to use one of SAP ERP's delivered workflows within the Closing Cockpit. These can be adapted to meet specific requirements. Some of these workflows also generate a worklist, which logs completion of each task in the worklist for each object. It also provides access to the messages encountered for a specific object.

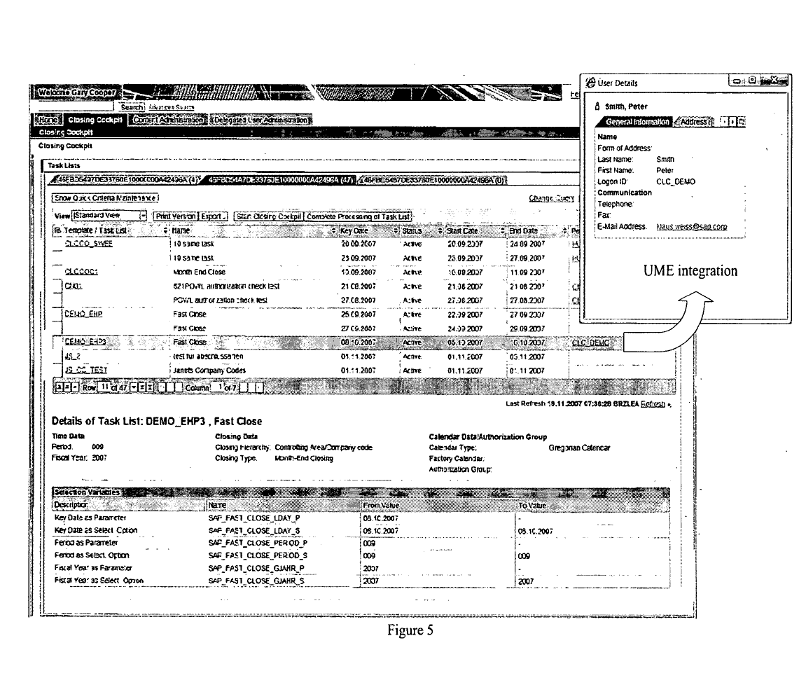

FIG. 5 illustrates an embodiment of a graphical user interface (GUI) of a Closing Cockpit displaying a worklist, according to an embodiment of the invention. The worklist could represent a worklist template in which an administrator user defines worktasks that have to be carried out during a closing process. The GUI contains links that enable opening nested windows to provide additional details. The Closing Cockpit is integrated with other applications that are accessed through the links, e.g. integration with User Management Engine™ (UME) to enable the display of user details when clicking on a user link.

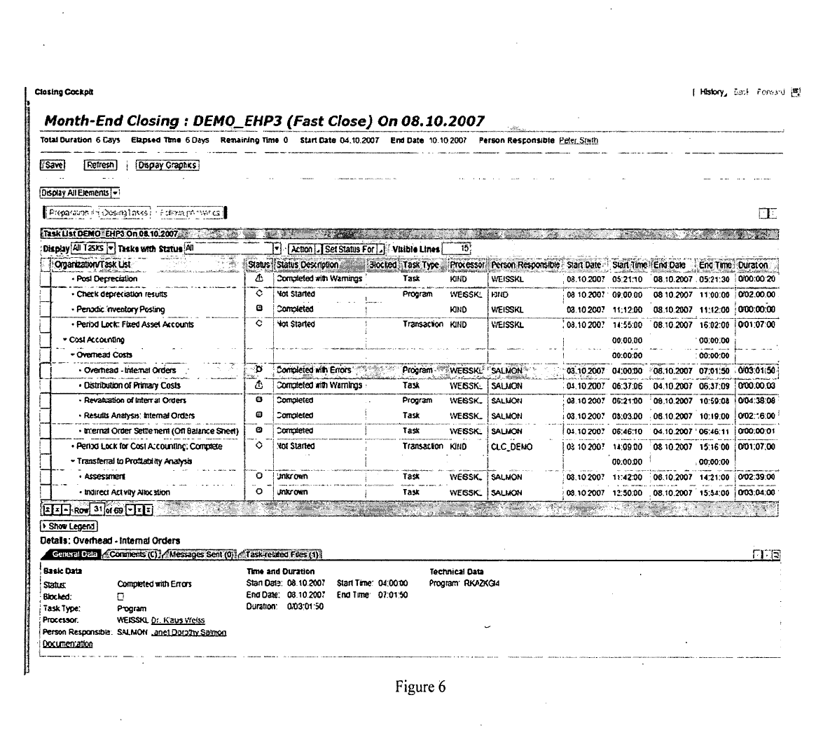

FIG. 6 illustrates an embodiment of a GUI of a Closing Cockpit displaying close worktasks in tree structure organized by organizational unit. The individual folders can represent a controlling area, one or more company codes, or a phase or a folder. The Closing Cockpit here also displays the status, responsible users or persons, and the duration of each close worktask.

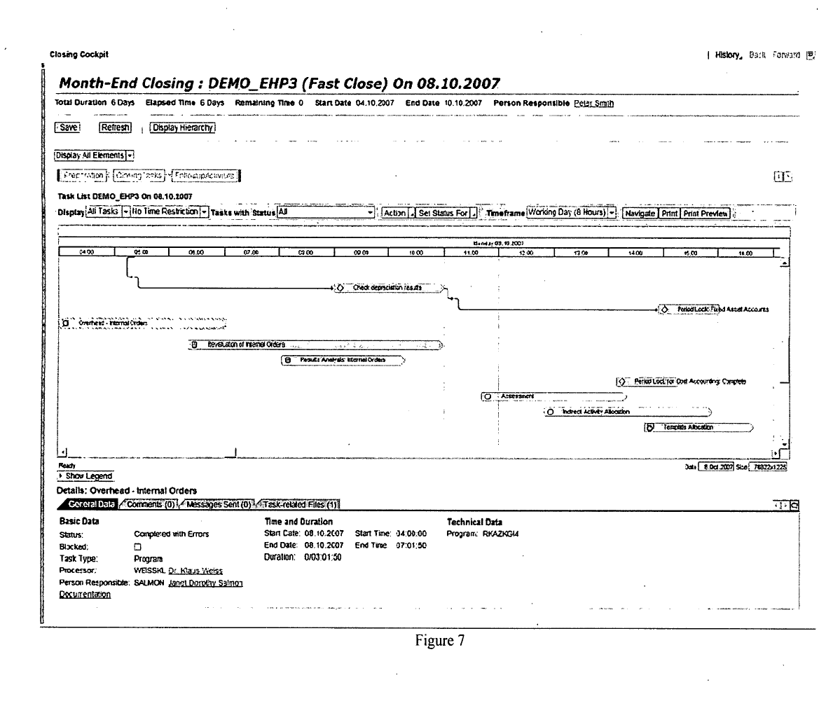

FIG. 7 illustrates an embodiment of a GUI of a Closing Cockpit displaying worktasks in a graphical view or a Gantt chart. The Closing Cockpit visualizes the close schedule with respect to calendar days, enabling stakeholders to see which tasks are to be performed and when, the relative duration of the tasks, dependencies between tasks, and the status of each task. The cockpit also visualizes the bottleneck in the closing process. It therefore may be used for process optimization. The Closing Cockpit provides access to all system logs, error logs, and user comments and stores this information for later audit. It records task times for each step and allows benchmarking.

In the above description numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Reference throughout this specification to “one embodiment” or “an embodiment” means that a particular feature, structure or characteristic described in connection with the embodiment is included in at least embodiment of the invention. Thus, the appearance of the phrases “in one embodiment” or “in an embodiment” in various places throughout this specification are not necessarily all referring to the same embodiment. Furthermore, the particular features, structures or characteristics may be combined in any suitable manner in one or more embodiments.

What is claimed is:

1. A computerized method comprising:
creating a process hierarchy in a local system, the process hierarchy includes a plurality of organizational levels;
creating a process worklist in the local system, the process worklist includes a plurality of worktasks grouped in accordance with the process hierarchy, each of the plurality of worktasks including one or more internal worktasks and one or more external worktasks;
displaying a plurality of worklist views, each of the plurality of worklist view includes a corresponding subset of the plurality of worktasks organized in accordance with the process hierarchy;
initiating from one of the plurality of worklist views an execution of an internal worktask on a local computer system; and
initiating from one of the plurality of worklist views an execution of an external worktask on an external computer system.

2. The method of claim 1 further comprising:
receiving detailed information in the local system relevant to the execution of one of the internal worktask or the external worktask; and
monitoring the execution of one of the internal worktask or the external worktask in one or more worklist views from the plurality of worklist views.

3. The method of claim 1, wherein creating the process worklist comprises:
creating a worklist template in the local system, wherein the worklist template includes the plurality of worktasks, each of the plurality of worktasks to be executed during a process; and
instantiating the worklist based on the worklist template, the worklist including the plurality of worktasks, each of the plurality of worktasks to be executed during an instance of the process.

4. The method of claim 3, wherein creating the worklist template comprises:
creating a process worktask in the worktask template;
associating the process worktask to a folder in accordance with the process hierarchy; and
defining a dependency of the execution of one of the plurality of worktasks from an execution of another of the plurality of worktasks.

5. The method of claim 4, wherein creating the process worktask comprises:
scheduling the execution of the process worktask; and
specifying one or more characteristics of the process worktask.

6. The method of claim 1, wherein displaying the plurality of worklist views comprises:
displaying an execution status of one of a worktask or a group of worktasks; and
providing access to one or more functions associated with the worktask in accordance with the execution status of the worktask.

7. The method of claim 1, wherein initiating the execution of the external worktask comprises:
invoking the external worktasks execution on the external computer system in response to a predefined condition.

8. A system comprising:
a local computer system in communication with one of more external computer systems; and
a cockpit including:
a worklist template of a plurality of worktasks grouped in accordance with a plurality of organizational levels of a process hierarchy, the worklist including one or more internal worktasks and one or more external worktasks,
a display module to visualize a worklist view, the worklist view includes a subset of the plurality of worktasks organized in accordance with the process hierarchy, and
a management module to initiate an execution of one of an internal worktask on the local system or an external worktask on an external system.

9. The system of claim 8 further comprising:
a persisting module to store a detailed information relevant to the execution of one of the internal worktask or the external worktask from the worklist.

10. The system of claim 8 further comprising:
an integrator to link the cockpit with an external system to
initiate an execution of the external worktask on the external system, and
receive a detailed information relevant to the execution of the external worktask.

11. The system of claim 8 further comprising:
a plurality of computer applications in communication with the cockpit to
execute the internal worktask and the external worktask, and
generate a detailed information relevant to the execution of the worktasks.

12. The system of claim 8, wherein the worklist template comprises:
a plurality of folders, each folder to encompass a subset of the plurality of worktasks to be executed within a process phase or by an organizational unit in accordance with the process hierarchy.

13. The system of claim 8, wherein the display module is coupled to the worklist template and to the management module to provide interface for:
creating the process worklist of a plurality of worktasks grouped in accordance with a plurality of organizational levels of a process hierarchy;
visualizing a detailed information related with the execution of the plurality of worktasks; and
initiating the execution of one of the internal worktask and the external worktask.

14. The system of claim 8, wherein the display module provides access to one or more functions in accordance with an execution status of a worktask.

15. A machine readable medium having instructions stored therein which when executed cause a machine to perform a set of operations comprising:
creating a process hierarchy in a local system, the process hierarchy includes a plurality of organizational levels;
creating a process worklist in the local system, the process worklist includes a plurality of worktasks grouped in accordance with the process hierarchy, each of the plurality of worktasks including one or more internal worktasks and one or more external worktasks;
displaying a plurality of worklist views, each of the plurality of worklist view includes a corresponding subset of the plurality of worktasks organized in accordance with the process hierarchy;
initiating from one of the plurality of worklist views an execution of an internal worktask on a local computer system; and
initiating from one of the plurality of worklist views an execution of an external worktask on an external computer system.

16. The machine readable medium of claim 15 having further instructions stored therein which when executed cause a machine to perform a set of operations further comprising:
receiving detailed information in the local system relevant to the execution of one of the internal worktask or the external worktask; and
monitoring the execution of one of the internal worktask or the external worktask in one or more worklist views from the plurality of worklist views.

17. The machine readable medium of claim 15, wherein creating the process worklist comprises:
creating a worklist template in the local system, wherein the worklist template includes the plurality of worktasks, each of the plurality of worktasks to be executed during a process; and
instantiating the worklist based on the worklist template, the worklist including the plurality of worktasks, each of the plurality of worktasks to be executed during an instance of the process.

18. The machine readable medium of claim 17, wherein creating the worklist template comprises:
creating a process worktask in the worktask template;
associating the process worktask to a folder in accordance with the process hierarchy; and
defining a dependency of the execution of one of the plurality of worktasks from one of an execution of another worktasks and providing an user input.

19. The machine readable medium of claim 18, wherein creating the process worktask comprises:
scheduling the execution of the process worktask; and
specifying one or more characteristics of the process worktask.

20. The machine readable medium of claim 15, wherein displaying the plurality of worklist views comprises:
displaying an execution status of one of a worktask or a group of worktasks; and
providing access to one or more functions associated with the worktask in accordance with the execution status of the worktask.

21. The machine readable medium of claim 15, wherein initiating the execution of the external worktask comprises:
invoking the external worktasks execution on the external computer system in response to a predefined condition.
